(19) United States
(12) Patent Application Publication
(10) Pub. No.: US 2011/0138866 A1
(43) Pub. Date: Jun. 16, 2011

(54) ACCESS IDENTIFICATION ASSEMBLY AND METHOD OF USING SAME

(75) Inventor: W. Kay Ponicall, Bloomfield Hills, MI (US)

(73) Assignee: LUKA Global, LLC, Bloomfield Hills, MI (US)

(21) Appl. No.: 12/639,237

(22) Filed: Dec. 16, 2009

(51) Int. Cl. E05B 15/00; E05B 41/00

(52) U.S. Cl. 70/266; 70/432

(57) ABSTRACT

An access identification assembly allows the owner of a piece of luggage or some other accessible structure to identify when someone has gained access to it. The assembly includes a housing which defines an interior space. The housing includes first and second openings. A locking member defines a fixed end, a movable end and an elongated body extending therebetween. The fixed end is fixedly secured to the housing and the movable end extends out and away from the housing. The movable end is selectively insertable into the housing to secure the access identification assembly. The access identification assembly also includes a releasing mechanism that is operatively connected to the housing for permanently unsecuring the access identification assembly. When either the releasing mechanism is broken or the locking member is severed, the user of the luggage knows that access has been obtained.

### BACKGROUND ART

1. Field of the Invention

The invention relates to an access identification assembly. More particularly, the invention relates to an access identification assembly that inhibits others from accessing an enclosure.

2. Description of the Related Art

Situations arise where one would like to prevent access of a particular space to others. When this situation arises, it is typical to prevent the access by locking the space, be it a home, office, safe, locker, luggage, and the like. Locking luggage has, however, become problematic in that the locks will be destroyed when the person's luggage is required to be transported via a major public carrier, such as an airline or train. Therefore, there is a need in the art to be able to inhibit the access of luggage and, if necessary, identify when a particular piece of luggage has been accessed.

### SUMMARY OF THE INVENTION

An access identification assembly includes a housing which defines an interior space. The housing includes first and second openings. A locking member defines a fixed end, a movable end and an elongated body extending therebetween. The fixed end is fixedly secured to the housing and the movable end extends out and away from the housing. The movable end is selectively insertable into the housing to secure the access identification assembly. The access identification assembly also includes a releasing mechanism that is operatively connected to the housing for permanently unsecuring the access identification assembly.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is an exploded perspective view of one embodiment of the invention shown being attached to an item;

FIG. 2 is a perspective view of the invention;

FIG. 3 is a top view of the invention with a part of the housing removed therefrom;

FIG. 4 is a cross-sectional side view taken along lines 4-4 of FIG. 3;

FIG. 5 is an exploded perspective view of the invention;

FIG. 6 is a perspective view of a second embodiment of the invention;

FIG. 7 is a top view of the second embodiment of the invention with a portion of the housing removed therefrom;

FIG. 8 is a cross-sectional side view taken along line 8-8 of FIG. 7; and

FIG. 9 is an exploded perspective view of the second embodiment of the invention.

### DETAILED DESCRIPTION OF THE PREFERRED EMBODIMENT

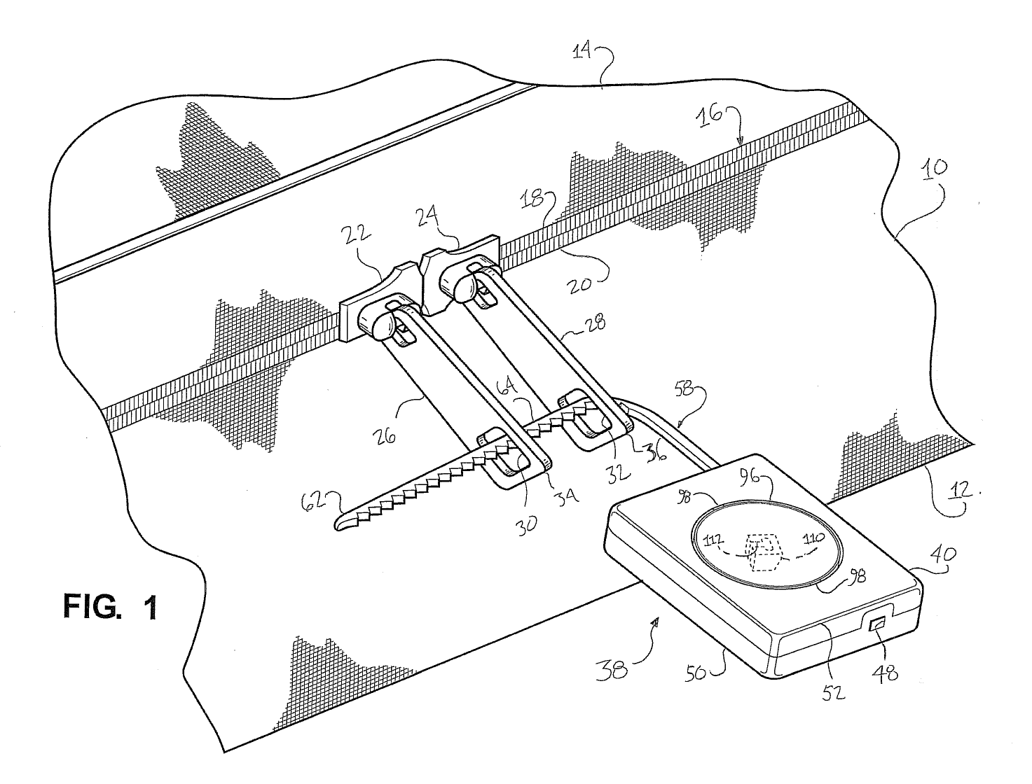

Referring to FIG. 1, a structure 10 is shown partially cutaway. The structure 10 is a piece of luggage having a base 12, a cover or top 14 and a closure device, generally shown at 16, disposed therebetween. The closure device 16 secures the top 14 over the base 12. In the embodiment shown, the closure device 16 a zipper having two rows of prongs 18, 20 and two zipper actuators 22, 24. Each zipper actuator 22, 24 either separates the rows of prongs 18, 20 or meshes them together to seal the top 14 over the base 12. Each zipper actuator 22, 24 includes a pull tab 26, 28 having a pull tab opening 30, 32 disposed at the distal end 34, 36 thereof. As may be appreciated by those skilled in the art, the luggage 10 is shown as an exemplary embodiment of a structure 10 that could be closed and that there are several other types of structures that may be used for this discussion.

One embodiment of the invention, an access identification assembly, is generally indicated at 38. The access identification assembly 38 is designed to provide the user of the luggage 10 an indication that the luggage 10 has been opened, unauthorized or authorized via a particular agency. By way of example, the luggage 10 may be relinquished over to the control of those working for an airline carrier. The luggage 10 may or may not be inspected by the Transportation Security Administration or some equivalent thereof. Regardless, the luggage 10 cannot be locked or the likelihood that the lock will be removed is great. The access identification assembly 38 provides a means to prevent the separation of the zipper actuators 22, 24 and if the access identification assembly 38 has been removed or destroyed, the user of the luggage will know that the luggage 10 has been accessed.

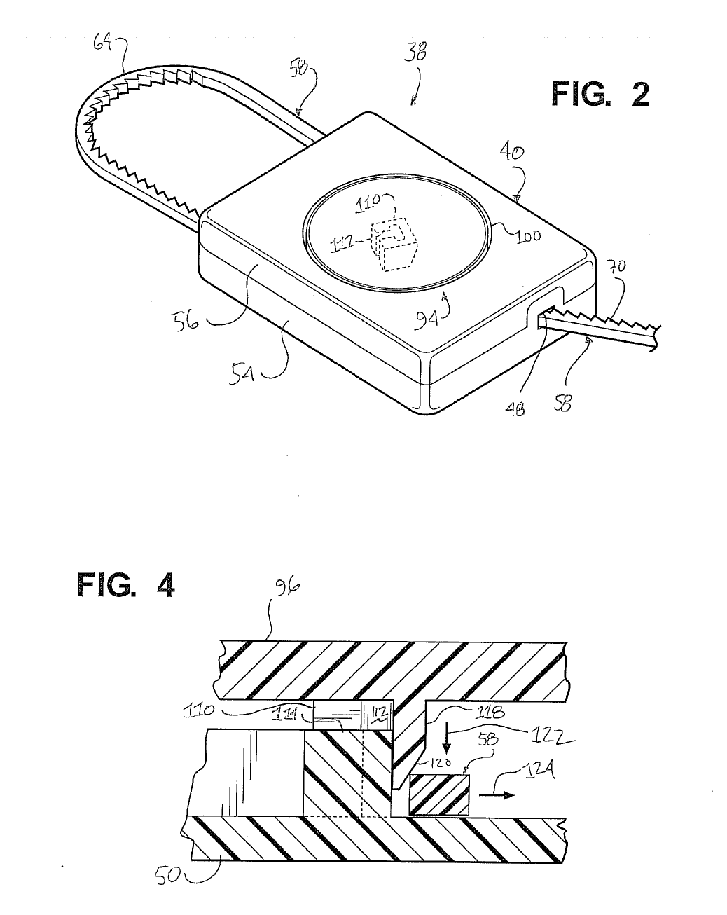

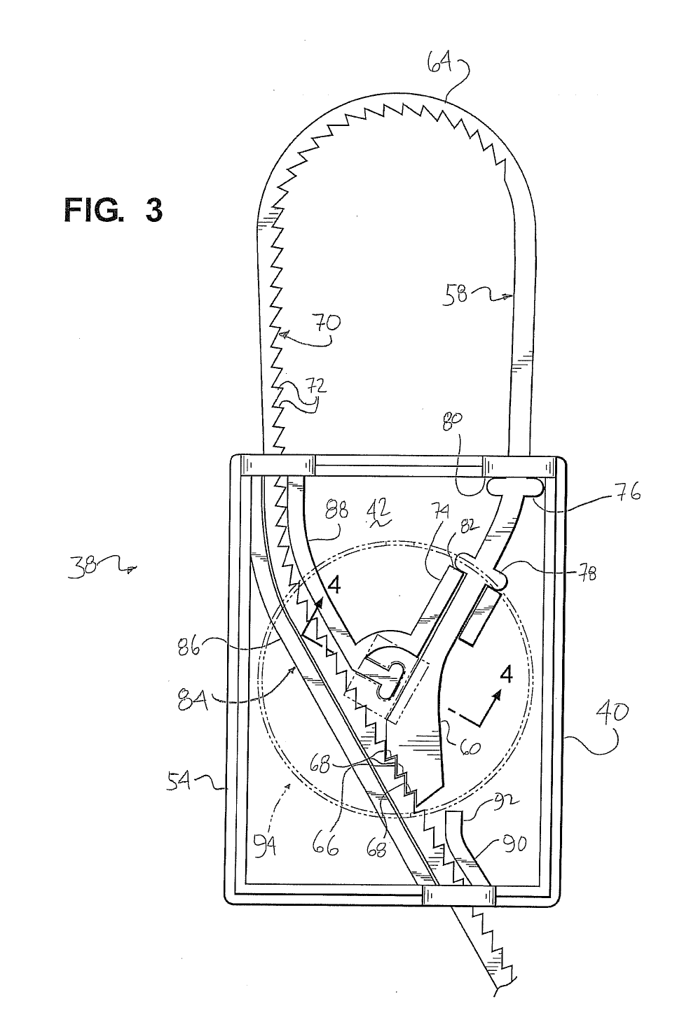

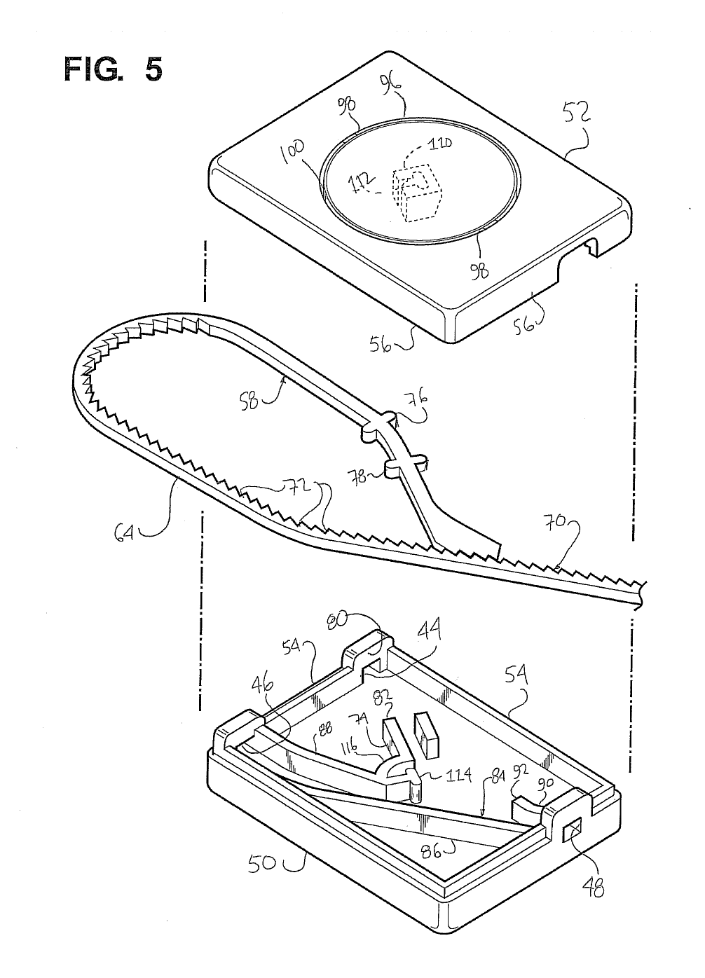

Referring to FIGS. 1 through 3, the access identification assembly includes a housing 40 that defines an interior space 42 (shown in FIG. 3). As is shown in FIG. 5, the housing 40 includes a first opening 44, a second opening 46 and third opening 48. These opening will be discussed in greater detail subsequently.

The housing 40 includes a back structure 50 and a cover plate 52. Each of the back structure 50 and the cover plate 52 include sides 54, 56, respectively, that matingly engage each other such that they complement each other and create an enclosed structure but for the openings 44, 46, 48.

The access identification assembly 38 also includes a locking member, generally indicated at 58. The locking member 58 defines a fixed end 60, a movable end 62 and an elongated body 64 extending therebetween. The fixed end 60 is fixedly secured to the housing 40, while the movable end 62 extends out and away from the housing 40 through the first opening 44. The movable end 62 is selectively insertable into the second opening 46 of the housing 40 to secure the access identification assembly 38. The locking member 58 is designed to be long enough such that if necessary, the movable end 62 may extend out the third opening 48 as is shown in many of the Figures.

The fixed end 60 of the locking member 58 includes a locking surface 66. The locking surface 66 is disposed inside the housing and is designed to lock a portion of the locking member 58 inside the housing 40. The locking surface 66 includes a plurality of locking teeth 68.

The elongated body 64 includes an abutment surface, generally shown at 70. The abutment surface 70 abuts against the locking surface 66 when the movable end 62 and the elongated body 64 are inserted into the housing 40. The abutment surface 70 includes a plurality of abutment teeth 72 that are designed to engage the plurality of locking teeth 68 of the locking surface 66. The plurality of abutment teeth 72 extend along a great deal of the elongated body 64 to accommodate situations when the items being secured, the pull tabs 26, 28 in the example shown in FIG. 1, are not able to be brought into close proximity to each other.

As is shown in FIG. 3, the fixed end 60 is positioned in a defined location. This defined location is created by a two sided orientation guide 74 that ensures the fixed end 60 and, more particularly, the plurality of locking teeth 68, are in a specific orientation. The exact location is further defined by protrusions 76, 78 formed in the locking member 58 extending out radially therefrom. The protrusions 76, 78 abut an inside surface 80 of the housing 40 and an end 82 of the orientation guide 74. Because the orientation guide 74 and the inside surface 80 are at fixed locations because they are formed out of the back structure 50, the protrusions 76, 78 prevent the elongated body 64 from moving laterally with respect to the housing 40. Therefore, the locking surface 66 and the plurality of locking teeth 68 are set in a defined position.

The abutment surface 70 engages the locking surface 66 when the movable end 62 and the elongated body 64 move through the housing 40. A channel 84 having an outer wall 86 and an inner wall 88 guide the elongated body 64 through the housing and out the third opening 38. Therefore, as the movable end is moved through the housing, the abutment surface engages the locking surface 66 locking the elongated body 64 from being removed from the housing, thus preventing access to the secured structure, e.g., the luggage 10. A second inner wall 90 is disposed in line with the first inner wall 88 but spaced apart therefrom. The space provided between the first inner wall 88 and the second inner wall 90 is a space that is occupied by the fixed end 60 of the locking member 58. The second inner wall 90 includes a flange 92 that extends away from the channel 84 to further guide the movable end 62 to the third opening 48.

The access identification assembly 38 includes a releasing mechanism generally indicated at 94. The releasing mechanism 94 is operatively connected to the housing 40 and permanently unsecures the access identification assembly 38 when it is operated upon. In the embodiment shown in FIGS. 1 through 5, the releasing mechanism 94 separates the abutment surface 70 from the locking surface 66.

The releasing mechanism 94 includes a button 96 that is fixedly secured to the cover plate 52 of the housing. The button 96 is secured to the cover plate 52 by a securing tong 98. In the embodiment shown in the Figures, there are two securing tongs 98 diametrically opposed to each other and extending between a hole 100 created in the cover plate 52 and the button 96. When the button 96 is depressed to activate the releasing mechanism 94, the securing tongs 98 are broken. Therefore, the button 96 must be pressed with sufficient force to break the securing tongs 98.

The button 96 includes a rotation inhibitor 110 having a sleeve 112 cut therethrough. The rotation inhibitor 110 receives a boss 114, extending upwardly from the back structure 50 to ensure the button 96 does not rotate with respect to the housing 40 after the securing tongs 98 are broken. As is shown in the embodiment, the orientation guide 74, the first inner wall 88 and the boss 114 are all connected via an arcuate wall 116.

Referring specifically to FIG. 4, the button 96 includes a spacer 118. The spacer includes a tapered edge 120. The tapered edge 120 moves in the direction of an arrow 122 when the button 96 is pressed. The tapered edge 120 engages the fixed end 60 of the locking member 58 and forces it in a direction as represented by a second arrow 124. This forces the fixed end 60 away from the elongated end 64 which, in turn, moves the locking surface 66 away from the abutment surface 70 to unlock the two surfaces 66, 70 allowing the removal of the movable end 62 back through the housing 40 and out to unlock the structure 10.

The access identification assembly 38 provides identification that access has been made to the luggage 10 because the button 96 has been broken from the cover plate 52 of the housing 40 and is not replaceable. Therefore, the person using the luggage 10 understands that access has been provided to someone and that an issue exists to the contents of the luggage 10, especially if the access was unauthorized.

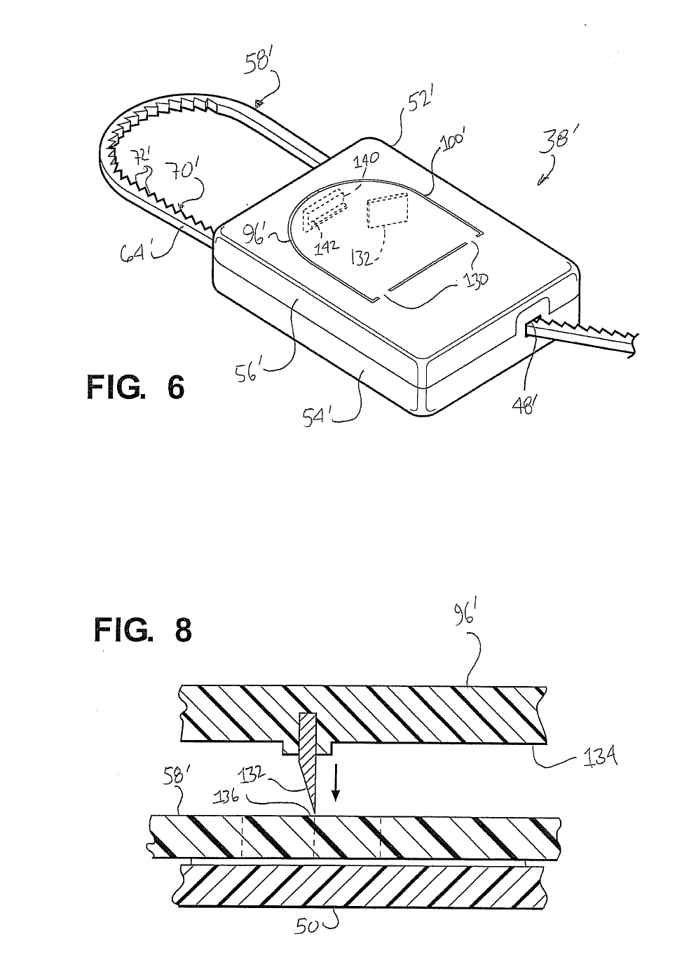

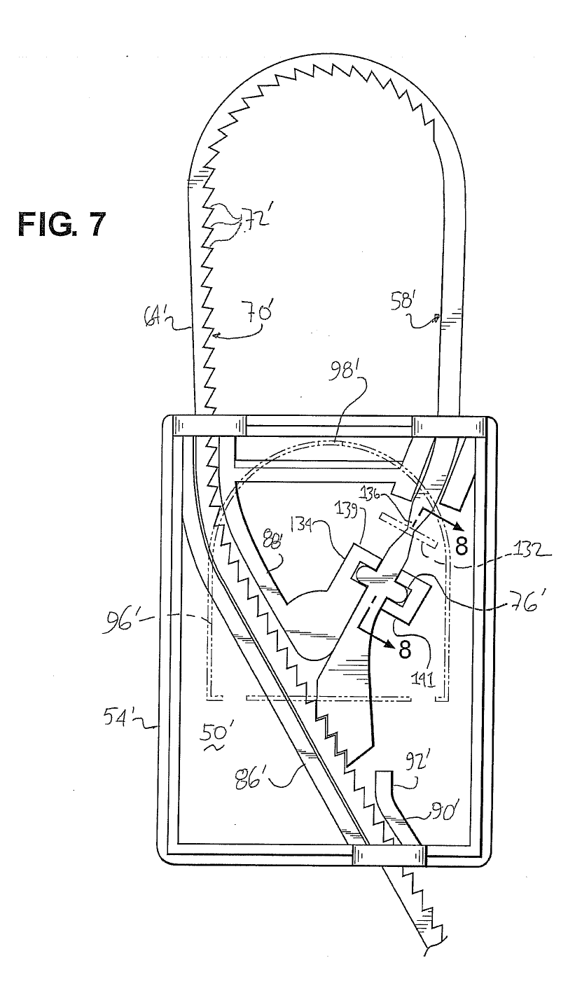

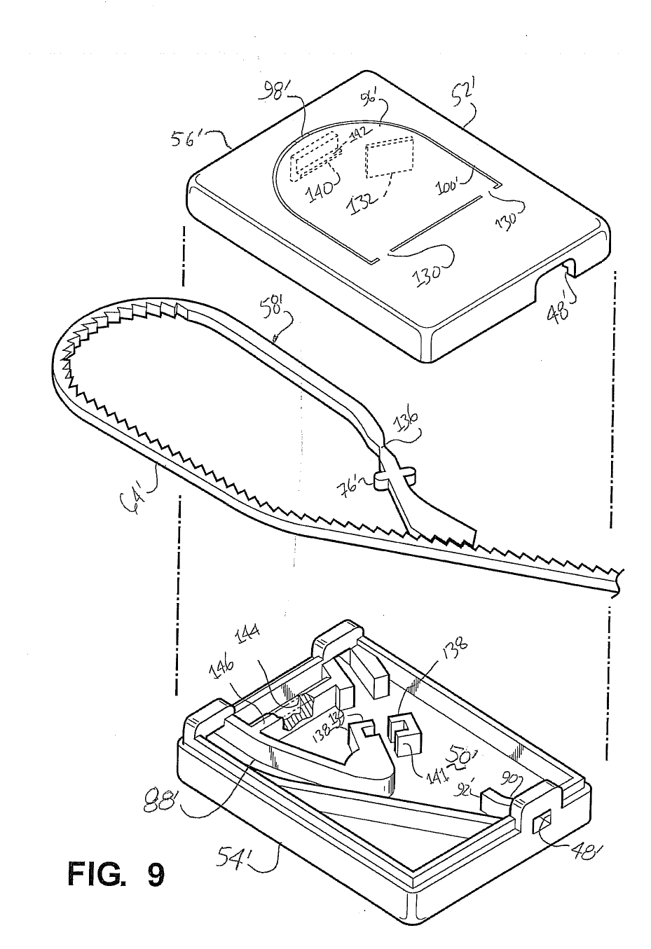

Referring now to FIGS. 6 through 9, a second embodiment of the access identification assembly is shown. In these Figures, like primed numerals represent that similar structure as that of the first embodiment, discussed above. This embodiment of the access identification assembly 38′ operates in a manner very similar to the first embodiment. In this embodiment, however, the locking surface 66′ is not separated from the abutment surface 70′ to obtain access. This embodiment differs in that the depression of the button 96′ severs the locking member 58′ preventing it from being able to retain the luggage 10 in a sealed condition.

The button 96′ rotates about a hinge axis defined by a hinge 130. The hinge 130 is a living hinge in that the material used to form the button 96′ is the same as that used to create the cover plate 52′ with a substantial amount of material removed along the hinge 130 such that pressing the button 96′ forces the bending of the material that connects the button 96′ to the cover plate 52′.

The button 96′ includes a cutting surface 132 that extends down from a bottom surface 134 of the button 96′. The cutting surface 132 is formed into the button 96′ and may be formed out of the same material as the button 96′ or it may be a formed from a different material, as a particular design may require. The cutting surface 132 is positioned such that it will cut the locking member 58′. In this embodiment, the locking member 58′ includes a narrowed portion 136′ designed to be oriented such that the cutting surface 132 cuts the locking member 58′ at a narrow portion 136. This reduces the force required to cut the locking member 58′.

The back structure 50′ includes a retainer 138 extending upwardly therefrom. The retainer 138 receives a single protrusion 76′ of the locking member 58′ therein. The retainer 138 has forward 139 and rearward 141 surfaces, thus only requiring a single protrusion 76′ to maintain the fixed end 60′ in a position where the locking surface 66′ is abutted by the abutment surface 70′.

The button 86′ includes a catch 140 at a forward end of the button 96′. The catch 140 includes a single tooth 142 extending laterally from the catch 140. The catch 140 extends downwardly from the bottom surface 134 of the button 96′.

A retention structure 146 extends upwardly from the back structure 50′ and is designed to receive the catch 140 of the button 96′. The retention structure 146 has a complementing tooth 144 designed to receive the single tooth 142 of the catch 140 and prevent the button 96′ from moving back away from the back structure.

In operation, the second embodiment of the access identification assembly 38′ receives the locking member 58′ in the housing 40′ through the second opening 46′. The abutment surface 70′ engages the locking surface 66′ and prevents the removal of the locking member 58′ from the housing 40′. In order to release that which is retained by the locking member 58′, the button 96′ is depressed with a force sufficient for the cutting surface 132 to cut the narrowed portion 136 of the locking member 58′. Because the locking member 58′ has been severed, the user of the luggage 10 will know that access has been made to the luggage 10 during the time that the luggage was out of the control of the user. The user may at that time report the incident or use a second access identification assembly 38′ to re-secure the luggage 10.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. An access identification assembly comprising:
a housing defining an interior space, said housing including first and second openings;
a locking member defining a fixed end, a movable end, and an elongated body extending therebetween, said fixed end fixedly secured to said housing and said movable end extending out and away from said housing and selectively insertable into said housing to secure said access identification assembly; and
a releasing mechanism operatively connected to said housing for permanently unsecuring said access identification assembly.

2. An access identification assembly as set forth in claim 1 wherein said releasing mechanism includes a button movable from a non-operated position to a releasing position allowing said locking member to be released from said housing.

3. An access identification assembly as set forth in claim 2 including a locking surface disposed inside said housing for locking a portion of said locking member inside said housing.

4. An access identification assembly as set forth in claim 3 wherein said elongated body includes an abutment surface abuttable against said locking surface when said movable end and said elongated body are inserted into said housing.

5. An access identification assembly as set forth in claim 4 wherein said button includes a cutting surface disposed within said housing and aligned to extend across a portion of said elongated body of said locking member such that said cutting surface cuts said elongated body when said button is pressed.

6. An access identification assembly as set forth in claim 5 wherein said button includes a hinge such that said button pivots about said hinge when said button is pressed.

7. An access identification assembly as set forth in claim 6 wherein said housing includes a retainer for securing said fixed end of said locking member inside said housing.

8. An access identification assembly as set forth in claim 6 wherein said housing includes a retainer for securing said fixed end of said locking member inside said housing.

9. An access identification assembly as set forth in claim 8 wherein said housing includes a channel for guiding said movable end of said locking member inside said housing.

10. An access identification assembly as set forth in claim 9 wherein said locking surface is secured to said fixed end.

11. An access identification assembly as set forth in claim 10 wherein said locking surface includes a plurality of locking teeth.

12. An access identification assembly as set forth in claim 11 wherein said abutment surface includes a plurality of engaging teeth to complement and engage said plurality of locking teeth.

13. An access identification assembly as set forth in claim 12 including a securing mechanism for securing said button in a compressed position after said locking member is cut.

14. An access identification assembly as set forth in claim 4 wherein said button includes a spacer depending down from said button into said housing, said spacer separating said abutment surface from said locking surface to allow the removal of said elongated body from said housing.

15. An access identification assembly as set forth in claim 14 wherein said housing includes a tower extending toward said button against which said spacer pushes said abutment and locking surfaces apart when said button is pressed into said housing.

16. An access identification assembly as set forth in claim 15 wherein said button includes a securing tong for securing said button to said housing.

17. An access identification assembly as set forth in claim 16 wherein said securing tong breaks when said button is pressed separating said button from said housing.

18. A method for preparing a structure to identify when the structure has been accessed with the use of an access identification assembly having a housing, a locking member and a releasing mechanism, the method comprising the steps of:
threading the locking member through a portion of the structure;
inserting the locking member into the housing to create a closed loop defined by the locking member and the housing; and
identifying activation of the releasing mechanism by the destruction of one component of the access identification assembly.

19. A method as set forth in claim 18 wherein the step of identifying activation includes identifying the severing of the locking member.

20. A method as set forth in claim 18 wherein the step of identifying activation includes identifying the severing of the locking member.

21. A method as set forth in claim 18 including the step of marking the access identification assembly to identify when the access identification assembly has been replaced.

22. A method as set forth in claim 20 wherein the step of marking includes the step of printing a serial number on the housing.
